(19) United States
(12) Patent Application Publication
(10) Pub. No.: US 2012/0035165 A1
(43) Pub. Date: Feb. 9, 2012

(54) Use of fungicidal compound compositions for controlling certain rust fungi

(75) Inventors: Karl-Wilhelm Münks, Meerbusch (DE); Heiko Rieck, Burscheid (DE); Ulrike Wachendorff-Neumann, Neuwied (DE); Ingo Wetcholowsky, Langenfeld (DE); Jose Augusto Geraldes, Ribeirao Preto - SP (BR)

(73) Assignee: Bayer CropScience AG, Monheim (DE)

(21) Appl. No.: 13/061,976

(22) PCT Filed: Aug. 21, 2009
(86) PCT No.: PCT/EP09/06056

§ 371 Date: May 23, 2011

(30) Foreign Application Priority Data
Sep. 3, 2008 (EP) 08163617.7
Nov. 4, 2008 (EP) 08168292.4

(51) Int. Cl. A01N 43/88; A01N 43/653; A01P 3/00; A01N 43/56

(52) U.S. Cl. 514/229.2; 514/406; 514/384; 514/383; 514/266.23

(57) ABSTRACT

The present invention relates to the use of a fungicidal composition comprising at least one carboxamide and at least one further compound selected from strobilurins or from triazoles, for controlling certain rust fungi, such as soy bean rust and coffee rust, in crop protection.

The present invention relates to the use of a fungicidal composition comprising at least one carboxamide and at least one further compound selected from strobilurins or from triazoles, for controlling certain rust fungi, such as soy bean rust and coffee rust, in crop protection.

Asian soy bean rust (ASR) can be caused by either of two fungal species, Phakopsora pachyrhizi or P. meibomiae. P. meibomiae has not been detected in the continental U.S., and is not known to be of economic importance to crop production. However, P. pachyrhizi, a species endemic to Asia, is a devastating disease. In untreated fields in Asia and South America, yield losses ranging from 10 to 80% have been reported due to premature defoliation, fewer seeds, lighter seeds and poor seed quality.

P. pachyrhizi is now present in most of the soy bean growing areas of the world, it originated in NE Asia and was first reported on soy bean in Africa in 1997. The first detection in the Americas was in Paraguay in 2001 , and from there it spread rapidly to all soybean-growing areas of Brazil. It was first recorded in the northern hemisphere in 2004 in Colombia. Hurricane Ivan in September of 2004 was most likely responsible for the recent introduction into the U S.

ASR is carried long distances by wind currents; however, field-to-field transmission through contaminated clothing is also common. The fungus is not seed-transmitted. Most of the knowledge about ASR was developed in subtropical and tropical areas of the world. As with any new disease, its epidemiology and resulting control strategies might change in the temperate growing areas of the U.S.

In addition to soybeans, the Asian soy bean rust fungus is able to infect over 30 legumes such as lima and butter beans, green beans, kidney beans, cowpeas, pigeon peas, yam bean is also a suitable host.

It is already known that numerous carboxamides show activity against Phakopsora ssp. (cf. WO 2006/131221, WO 2007/071656). Even if their activity is good at high application rates, in some cases with lower application rates, it is unsatisfactory. Moreover, due to the steadily increasing incidences and levels of resistance of Phakopsora ssp against numerous active ingredients there is a strong need for active ingredient compositions that can be used to fight the divulgence of soybean rust.

It has now been found that fungicidal compositions comprising
(I) at least one carboxamide selected from the group consisting of
(I-1) N-[2-(1,3-dimethylbutyl)phenyl]-5-fluoro-1,3-dimethyl-1H-pyrazole-4-carbox-amide;
(I-2) N-(3′,4′-dichloro-5-fluoro-1,1′-biphenyl-2-yl)-3-(difluoromethyl)-1-methyl-1H-pyrazole-4-carboxamide;
(I-3) N-{2-[1,1′-bi(cyclopropyl)-2-yl]phenyl}-1-methyl-3-(difluoromethyl)-1H-pyrazole-4-carboxamide;
(I-4) 3-(difluoromethyl)-1-methyl-N-[9-(propan-2-yl)-1,2,3,4-tetrahydro-1,4-methanonaphthalen-6-yl]-1H-pyrazole-4-carboxamide;
(I-5) N-(3′,4′-dichlorobiphenyl-2-yl)-3-(difluoromethyl)-1-methyl-1H-pyrazole-4-carboxamide;
(I-6) N-(2′,4′-dichlorobiphenyl-2-yl)-3-(difluoromethyl)-1-methyl-1H-pyrazole-4-carboxamide;
(I-7) 3-(difluoromethyl)-N-[2-(1,1,2,3,3,3-hexafluoropropoxy)phenyl]-1-methyl-1H-pyrazole-4-carboxamide;
(I-8) 3-(difluoromethyl)-1-methyl-N-[2-(1,1,2,2-tetrafluoroethoxy)phenyl]-1H-pyrazole-4-carboxamide;
(I-9) 3-(difluoromethyl)-1-methyl-N-(3′,4′,5′-trifluorobiphenyl-2-yl)-1H-pyrazole-4-carboxamide;

and at least one further compound selected from (II) or (III)

(II) strobilurins, selected from the group consisting of
(II-1) fluoxastrobin;
(II-2) trifloxystrobin

or from

(III) triazoles, selected from the group consisting of
(III-1) prothioconazole;
(III-2) tebuconazole and
(III-3) fluquinconazole

can be used for controlling certain rust fungi, such as soy bean rust and coffee rust, in crop protection.

N-[2-(1,3-dimethylbutyl)phenyl]-5-fluoro-1,3-dimethyl-1H-pyrazole-4-carboxamide (Compound I-1) and its manufacturing process starting from known and commercially available compounds is described in WO 03/010149.

N-(3′,4′-dichloro-5-fluoro-1,1′-biphenyl-2-yl)-3-(difluoromethyl)-1-methyl-1H-pyrazole-4-carboxamide (Compound I-2) and its manufacturing process starting from known and commercially available compounds is described in WO 03/070705.

N-{2-[1,1′-bi(cyclopropyl-2-yl]phenyl}-1-methyl-3-(difluoromethyl)-1H-pyrazole-4-carboxamide (Compound I-3), also known as sedaxane, and its manufacturing process starting from known and commercially available compounds is described in WO 03/074491, WO 2006/015865 and WO 2006/015866. Sedaxane generally denotes the mixture of 2 cis-isomers 2′-[(1RS,2RS)-1,1′-bicycloprop-2-yl]-3-(difluoromethyl)-1-methylpyrazole-4-carboxanilide and 2 trans-isomers 2′-[(1RS,2SR)-1,1′-bicycloprop-2-yl]-3-(difluoromethyl)-1-methylpyrazole-4-carboxanilide.

3-(difluoromethyl)-1-methyl-N-[9-(propan-2-yl)-1,2,3,4-tetrahydro-1,4-methanonaphthalen-6-yl]-1H-pyrazole-4-carboxamide (compound I-4), also known as isoprazam, and its manufacturing process starting from known and commercially available compounds is described in WO 2004/035589. Isopyrazam generally denotes the mixture of 2 syn-isomers 3-(difluoromethyl)-1-methyl-N-[(1RS,4SR,9RS)-1,2,3,4-tetrahydro-9-isopropyl-1,4-methanonaphthalen-5-yl]pyrazole-4-carboxamide and 2 anti-isomers 3 -(difluoromethyl)-1-methyl-N-[(1RS,4SR,9SR)-1,2,3,4-tetrahydro-9-isopropyl-1,4-methanonaphthalen-5-yl]pyrazole-4-carboxamide.

N-(3′,4′-dichlorobiphenyl-2-yl)-3-(difluoromethyl)-1-methyl-1H-pyrazole-4-carboxamide (compound I-5), N-(2′,4′-dichlorobiphenyl-2-yl)-3-(difluoromethyl)-1-methyl-1H-pyrazole-4-carboxamide (compound I-6) 3-(difluoromethyl)-N-[2-(1,1,2,3,3,3-hexafluoropropoxy)phenyl]-1-methyl-1H-pyrazole-4-carboxamide (compound I-7), 3-(difluoromethyl)-1-methyl-N-[2-(1,1,2,2-tetrafluoroethoxy)phenyl]-1H-pyrazole-4-carboxamide (compound I-8) and 3-(difluoromethyl)-1-methyl-N-(3′,4′,5′-trifluorobiphenyl-2-yl)-1H-pyrazole-4-carboxamide (compound I-9) and their manufacturing processes starting from known and commercially available compounds are described in WO 2005/123690.

Fluoxastrobin (compound II-1) and its manufacturing process starting from known and commercially available compounds is described in DE-A 196 02 095.

Trifloxystrobin (compound II-2) and its manufacturing process starting from known and commercially available compounds is described in EP-A 0 460 575.

Prothioconazole (compound III-1) and its manufacturing process starting from known and commercially available compounds is described in WO 96/16048.

Tebuconazole (compound III-2) and its manufacturing process starting from known and commercially available compounds is described in EP-A 0 040 345.

Fluquinconazole (compound III-3) and its manufacturing process starting from known and commercially available compounds is described in EP-A 0 183 458.

If appropriate, the carboxamides of group (I), the strobilurines of group (II) and the azoles of group (III) can be present as mixtures of various possible isomeric forms, in particular stereoisomers, such as, for example, E and Z, threo and erythro, and also optical isomers, and, if appropriate, also of tautomers. The formula (I) includes both the E and the Z isomers, and the threo and erythro and also the optical isomers, any mixtures of these isomers and the possible tautomeric forms.

The compounds according to the invention have strong microbicidal action and can be used for controlling certain rust fungi, such as soy bean rust and coffee rust, in crop protection.

Preferred embodiments of the present invention are shown in the subsequent tables

| Carboxamide (I) | Stobilurin (II) |
|---|---|
| (I-1) N-[2-(1,3-dimethylbutyl)phenyl]-5-fluoro-1,3-dimethyl-1H- | (II-1) fluoxastrobin |
| pyrazole-4-carboxamide; | |
| (I-2) N-(3′,4′-dichloro-5-fluoro-1,1′-biphenyl-2-yl)-3- | (II-1) fluoxastrobin |
| (difluoromethyl)-1-methyl-1H-pyrazole-4-carboxamide; | |
| (I-3) N-{2-[1,1′-bi(cyclopropyl)-2-yl]phenyl}-1-methyl-3- | (II-1) fluoxastrobin |
| (difluoromethyl)-1H-pyrazole-4-carboxamide; | |
| (I-4) 3-(difluoromethyl)-1-methyl-N-[9-(propan-2-yl)-1,2,3,4- | (II-1) fluoxastrobin |
| tetrahydro-1,4-methanonaphthalen-6-yl]-1H-pyrazole-4-carboxamide; | |
| (I-5) N-(3′,4′-dichlorobiphenyl-2-yl)-3-(difluoromethyl)-1-methyl- | (II-1) fluoxastrobin |
| 1H-pyrazole-4-carboxamide; | |
| (I-6) N-(2′,4′-dichlorobiphenyl-2-yl)-3-(difluoromethyl)-1-methyl- | (II-1) fluoxastrobin |
| 1H-pyrazole-4-carboxamide | |
| (I-7) 3-(difluoromethyl)-N-[2-(1,1,2,3,3,3-hexafluoropropoxy)- | (II-1) fluoxastrobin |
| phenyl]-1-methyl-1H-pyrazole-4-carboxamide | |
| (1-8) 3-(difluoromethyl)-1-methyl-N-[2-(1,1,2,2-tetrafluoroethoxy)- | (II-1) fluoxastrobin |
| phenyl]-1H-pyrazole-4-carboxamide; | |
| (1-9) 3-(difluoromethyl)-1-methyl-N-(3′,4′,5′-trifluorobiphenyl-2-yl)- | (II-1) fluoxastrobin |
| 1H-pyrazole-4-carboxamide; | |
| (I-1) N-[2-(1,3-dimethylbutyl)phenyl]-5-fluoro-1,3-dimethyl-1H- | (II-2) trifloxystrobin |
| pyrazole-4-carboxamide; | |
| (I-2) N-(3′,4′-dichloro-5-fluoro-1,1′-biphenyl-2-yl)-3- | (II-2) trifloxystrobin |
| (difluoromethyl)-1-methyl-1H-pyrazole-4-carboxamide; | |
| (I-3) N-{2-[1,1′-bi(cyclopropyl)-2-yl]phenyl}-1-methyl-3- | (II-2) trifloxystrobin |
| (difluoromethyl)-1H-pyrazole-4-carboxamide; | |
| (I-4) 3-(difluoromethyl)-1-methyl-N-[9-(propan-2-yl)-1,2,3,4- | (II-2) trifloxystrobin |
| tetrahydro-1,4-methanonaphthalen-6-yl]-1H-pyrazole-4-carboxamide; | |
| (I-5) N-(3′,4′-dichlorobiphenyl-2-yl)-3-(difluoromethyl)-1-methyl- | (II-2) trifloxystrobin |
| 1H-pyrazole-4-carboxamide; | |
| (I-6) N-(2′,4′-dichlorobiphenyl-2-yl)-3-(difluoromethyl)-1-methyl- | (II-2) trifloxystrobin |
| 1H-pyrazole-4-carboxamide | |
| (I-7) 3-(difluoromethyl)-N-[2-(1,1,2,3,3,3-hexafluoropropoxy)- | (II-2) trifloxystrobin |
| phenyl]-1-methyl-1H-pyrazole-4-carboxamide | |
| (1-8) 3-(difluoromethyl)-1-methyl-N-[2-(1,1,2,2-tetrafluoroethoxy)- | (II-2) trifloxystrobin |
| phenyl]-1H-pyrazole-4-carboxamide; | |
| (1-9) 3-(difluoromethyl)-1-methyl-N-(3′,4′,5′-trifluorobiphenyl-2-yl)- | (II-2) trifloxystrobin |
| 1H-pyrazole-4-carboxamide; | |

| Carboxamide (I) | Triazole (III) |
|---|---|
| (I-1) N-[2-(1,3-dimethylbutyl)phenyl]-5-fluoro-1,3-dimethyl-1H- | (III-1) prothioconazole; |
| pyrazole-4-carboxamide; | |
| (I-2) N-(3′,4′-dichloro-5-fluoro-1,1′-biphenyl-2-yl)-3- | (III-1) prothioconazole; |
| (difluoromethyl)-1-methyl-1H-pyrazole-4-carboxamide; | |
| (I-3) N-{2-[1,1′-bi(cyclopropyl)-2-yl]phenyl}-1-methyl-3- | (III-1) prothioconazole; |
| (difluoromethyl)-1H-pyrazole-4-carboxamide; | |
| (I-4) 3-(difluoromethyl)-1-methyl-N-[9-(propan-2-yl)-1,2,3,4- | (III-1) prothioconazole; |
| tetrahydro-1,4-methanonaphthalen-6-yl]-1H-pyrazole-4-carboxamide; | |
| (I-5) N-(3′,4′-dichlorobiphenyl-2-yl)-3-(difluoromethyl)-1-methyl- | (III-1) prothioconazole; |
| 1H-pyrazole-4-carboxamide; | |
| (I-6) N-(2′,4′-dichlorobiphenyl-2-yl)-3-(difluoromethyl)-1-methyl- | (III-1) prothioconazole |
| 1H-pyrazole-4-carboxamide | |
| (I-7) 3-(difluoromethyl)-N-[2-(1,1,2,3,3,3-hexafluoropropoxy)- | (III-1) prothioconazole |
| phenyl]-1-methyl-1H-pyrazole-4-carboxamide | |
| (1-8) 3-(difluoromethyl)-1-methyl-N-[2-(1,1,2,2-tetrafluoroethoxy)- | (III-1) prothioconazole |
| phenyl]-1H-pyrazole-4-carboxamide; | |
| (1-9) 3-(difluoromethyl)-1-methyl-N-(3′,4′,5′-trifluorobiphenyl-2-yl)- | (III-1) prothioconazole |
| 1H-pyrazole-4-carboxamide; | |
| (I-1) N-[2-(1,3-dimethylbutyl)phenyl]-5-fluoro-1,3-dimethyl-1H- | (III-2) tebuconazole |
| pyrazole-4-carboxamide; | |
| (I-2) N-(3′,4′-dichloro-5-fluoro-1,1′-biphenyl-2-yl)-3- | (III-2) tebuconazole |
| (difluoromethyl)-1-methyl-1H-pyrazole-4-carboxamide; | |
| (I-3) N-{2-[1,1′-bi(cyclopropyl)-2-yl]phenyl}-1-methyl-3- | (III-2) tebuconazole |
| (difluoromethyl)-1H-pyrazole-4-carboxamide; | |
| (I-4) 3-(difluoromethyl)-1-methyl-N-[9-(propan-2-yl)-1,2,3,4- | (III-2) tebuconazole |
| tetrahydro-1,4-methanonaphthalen-6-yl]-1H-pyrazole-4-carboxamide; | |
| (I-5) N-(3′,4′-dichlorobiphenyl-2-yl)-3-(difluoromethyl)-1-methyl- | (III-2) tebuconazole |
| 1H-pyrazole-4-carboxamide; | |
| (I-6) N-(2′,4′-dichlorobiphenyl-2-yl)-3-(difluoromethyl)-1-methyl- | (III-2) tebuconazole |
| 1H-pyrazole-4-carboxamide | |
| (I-7) 3-(difluoromethyl)-N-[2-(1,1,2,3,3,3-hexafluoropropoxy)- | (III-2) tebuconazole |
| phenyl]-1-methyl-1H-pyrazole-4-carboxamide | |
| (1-8) 3-(difluoromethyl)-1-methyl-N-[2-(1,1,2,2-tetrafluoroethoxy)- | (III-2) tebuconazole |
| phenyl]-1H-pyrazole-4-carboxamide; | |
| (1-9) 3-(difluoromethyl)-1-methyl-N-(3′,4′,5′-trifluorobiphenyl-2-yl)- | (III-2) tebuconazole |
| 1H-pyrazole-4-carboxamide; | |
| (I-1) N-[2-(1,3-dimethylbutyl)phenyl]-5-fluoro-1,3-dimethyl-1H- | (III-3) fluquinconazole |
| pyrazole-4-carboxamide; | |
| (I-2) N-(3′,4′-dichloro-5-fluoro-1,1′-biphenyl-2-yl)-3-(difluoro- | (III-3) fluquinconazole |
| methyl)-1-methyl-1H-pyrazole-4-carboxamide; | |
| (I-3) N-{2-[1,1′-bi(cyclopropyl)-2-yl]phenyl}-1-methyl-3-(difluoro- | (III-3) fluquinconazole |
| methyl)-1H-pyrazole-4-carboxamide; | |
| (I-4) 3-(difluoromethyl)-1-methyl-N-[9-(propan-2-yl)-1,2,3,4-tetra- | (III-3) fluquinconazole |
| hydro-1,4-methanonaphthalen-6-yl]-1H-pyrazole-4-carboxamide; | |
| (I-5) N-(3′,4′-dichlorobiphenyl-2-yl)-3-(difluoromethyl)-1-methyl- | (III-3) fluquinconazole |
| 1H-pyrazole-4-carboxamide; | |
| (I-6) N-(2′,4′-dichlorobiphenyl-2-yl)-3-(difluoromethyl)-1-methyl- | (III-3) fluquinconazole |
| 1H-pyrazole-4-carboxamide | |
| (I-7) 3-(difluoromethyl)-N-[2-(1,1,2,3,3,3-hexafluoropropoxy)- | (III-3) fluquinconazole |
| phenyl]-1-methyl-1H-pyrazole-4-carboxamide | |
| (1-8) 3-(difluoromethyl)-1-methyl-N-[2-(1,1,2,2-tetrafluoroethoxy)- | (III-3) fluquinconazole |
| phenyl]-1H-pyrazole-4-carboxamide; | |
| (1-9) 3-(difluoromethyl)-1-methyl-N-(3′,4′,5′-trifluorobiphenyl-2-yl)- | (III-3) fluquinconazole |
| 1H-pyrazole-4-carboxamide; | |

In a most preferred embodiment of the present invention the fungicidal composition comprises (I-2) N-(3′,4′-dichloro-5-fluoro-1,1′-biphenyl-2-yl)-3-(difluoromethyl)-1-methyl-1H-pyrazole-4-carboxamide and (III-1) prothioconazole.

The fungicidal compositions according to the present invention comprise the carboxamide (I) and the strobilurine (II) or the triazole (III) in a ratio of 50:1 to 1:50 (I)/(II) or (I)/(III), preferably in a ratio of 10:1 to 1:10 (I)/(II) or (I)/(III), most preferably in a ratio of 5:1 to 1:5 (I)/(II) or (I)/(III).

The following diseases of soy bean plants can preferably be controlled by the compound compositions according to the present invention:

alternaria leaf spot (Alternaria spec. atrans tenuissima), anthracnose (Colletotrichum gloeosporoides dematium var. truncatum), brown spot (Septoria glycines), cercospora leaf spot and blight (Cercospora kikuchii), choanephora leaf blight (Choanephora infundibulifera trispora (syn.)), dactuliophora leaf spot (Dactuliophora glycines), downy mildew (Peronospora manshurica), drechslera blight (Drechslera glycini), frogeye leaf spot (Cercospora sojina), leptosphaerulina leaf spot (Leptosphaerulina trifolii), phyllostica leaf spot (Phyllosticta sojaecola), powdery mildew (Microsphaera diffusa), pyrenochaeta leaf spot (Pyrenochaeta glycines), rhizoctonia aerial, foliage, and web blight (Rhizoctonia solani), rust (Phakopsora pachyrhizi), scab (Sphaceloma glycines), stemphylium leaf blight (Stemphylium botryosum), target spot (Corynespora cassiicola), black root rot (Calonectria crotalariae), charcoal rot (Macrophomina phaseolina), fusarium blight or wilt, root rot, and pod and collar rot (Fusarium oxysporum, Fusarium orthoceras, Fusarium semitectum, Fusarium equiseti), mycoleptodiscus root rot (Mycoleptodiscus terrestris), neocosmospora (Neocosmopspora vasinfecta), pod and stem blight (Diaporthe phaseolorum), stem canker (Diaporthe phaseolorum var. caulivora), phytophthora rot (Phytophthora megasperma), brown stem rot (Phialophora gregata), pythium rot (Pythium aphanidermatum, Pythium irregulare, Pythium debaryanum, Pythium myriotylum, Pythium ultimum), rhizoctonia root rot, stem decay, and damping-off (Rhizoctonia solani), sclerotinia stem decay (Sclerotinia sclerotiorum), sclerotinia southern blight (Sclerotinia rolfsii), thielaviopsis root rot (Thielaviopsis basicola). Particular preference is given to using the fungicidal compositions according to the present invention for controlling Phakopsora pachyrhizi and Phakopsora meibomiae.

In the present case, unwanted microorganisms are to be understood as meaning the organisms mentioned above. The compounds according to the invention can therefore be employed for protecting plants against attack by the abovementioned pathogens within a certain period of time after the treatment. The period of time within which protection is effected generally extends from 1 to 10 days, preferably from 1 to 7 days, after the treatment of the plants with the active compounds.

The fact that the active compounds, in the concentrations required for controlling plant diseases, are well tolerated by plants permits the treatment of above-ground parts of plants, of vegetative propagation material and seed, and of the soil.

In conjunction with the present invention “controlling” denotes a significant reduction of the rust infestation in comparison to the untreated crop, more preferably the infestation is essentially diminished (50-79%), most preferably the infestation is totally suppressed (80-100%).

In this context, the fungicidal compositions according to the present invention can be used with particularly good results for controlling soy bean diseases, such as, for example, against Phakopsora species.

The fungicidal compositions according to the present invention are also suitable for increasing the yield. Moreover, they display a low degree of toxicity and are tolerated well by plants.

All plants and plant parts can be treated in accordance with the invention. Plants are understood as meaning, in the present context, all plants and plant populations, such as desired and undesired wild plants or crop plants (including naturally occurring crop plants). Crop plants may be plants which can be obtained by conventional breeding and optimization methods or else by biotechnological and genetic engineering methods or by combinations of these methods, including the transgenic plants and including the plant varieties capable or not capable of being protected by plant breeders' rights. Plant parts are to be understood as meaning all above-ground and subterranean parts and organs of the plants, such as shoot, leaf, flower and root, examples which may be mentioned being leaves, needles, stalks, stems, flowers, fruiting bodies, fruits and seeds, and also roots, tubers and rhizomes. The plant parts also include harvested material and vegetative and generative propagation material, for example cuttings, tubers, rhizomes, slips and seeds.

The treatment according to the invention with the active compounds, of the plants and plant parts, is carried out directly or by acting on their environment, habitat, or store by the customary treatment methods, for example by immersion, spraying, vaporizing, fogging, broadcasting, painting on and, in the case of propagation material, in particular in the case of seeds, furthermore by coating with one or more coats.

Depending on their respective physical and/or chemical properties, the active compounds can be converted to the customary formulations, such as solutions, emulsions, suspensions, powders, foams, pastes, granules, aerosols, very fine capsules in polymeric substances and in coating compositions for seed, and also ULV cold- and warm-fogging formulations.

These formulations are produced in a known manner, for example by mixing the active compounds with extenders, that is liquid solvents, pressurized liquefied gases and/or solid carriers, optionally with the use of surface-active agents, that is emulsifiers and/or dispersants and/or foam formers. If the extender used is water, it is also possible to employ for example organic solvents as cosolvents. Suitable liquid solvents are essentially: aromatics, such as xylene, toluene or alkylnaphthalenes, chlorinated aromatics or chlorinated aliphatic hydrocarbons, such as chlorobenzenes, chloroethylenes or methylene chloride, aliphatic hydrocarbons, such as cyclohexane or paraffins, for example mineral oil fractions, alcohols, such as butanol or glycol as well as their ethers and esters, ketones, such as acetone, methyl ethyl ketone, methyl isobutyl ketone or cyclohexanone, strongly polar solvents, such as dimethylformamide and dimethyl sulphoxide, and also water. Liquefied gaseous extenders or carriers are those liquids which are gaseous at ambient temperature and at atmospheric pressure, for example aerosol propellants such as halogenated hydrocarbons and also butane, propane, nitrogen and carbon dioxide. As solid carriers there are suitable: for example ground natural minerals, such as kaolins, clays, talc, chalk, quartz, attapulgite, montmorillonite or diatomaceous earth, and ground synthetic minerals, such as finely divided silica, alumina and silicates. As solid carriers for granules there are suitable: for example crushed and fractionated natural rocks such as calcite, pumice, marble, sepiolite and dolomite, and also synthetic granules of inorganic and organic meals, and granules of organic material such as sawdust, coconut shells, maize cobs and tobacco stalks. As emulsifiers and/or foam formers there are suitable: for example non-ionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and protein hydrolysates. As dispersants there are suitable: for example lignosulphite waste liquors and methylcellulose.

Tackifiers such as carboxymethylcellulose and natural and synthetic polymers in the form of powders, granules or latices, such as gum arabic, polyvinyl alcohol and polyvinyl acetate, as well as natural phospholipids, such as cephalins and lecithins, and synthetic phospholipids, can be used in the formulations. Other possible additives are mineral and vegetable oils.

It is possible to use colorants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc.

The formulations in general contain between 0.1 and 95 percent by weight of active compounds, preferably between 0.5 and 90%.

The compound combinations according to the present invention, as such or in their formulations, can also be used as a mixture with known fungicides, bactericides, acaricides, nematicides, or insecticides, for example, to broaden the activity spectrum or prevent the development of resistance. In many instances, synergistic effects are obtained, i.e. the activity of the mixture exceeds the activity of the individual components.

The active compound combinations according to the invention can be employed as such, in the form of their formulations or the use forms prepared therefrom, such as ready-to-use solutions, suspensions, wettable powders, pastes, soluble powders, dusts and granules. They are applied in the customary manner, for example by pouring, spraying, atomizing, broadcasting, dusting, foaming, painting on and the like. It is furthermore possible to apply the active compounds by the ultra-low-volume method, or to inject the active compound preparation or the active compound itself into the soil. The seed of the plants can also be treated.

When employing the compound combinations according to the present invention as fungicides, the application rates can be varied within a substantial range, depending on the type of application. In the treatment of plant parts, the application rates of active compound are generally between 0.1 and 10 000 g/ha, preferably between 10 and 1000 g/ha. For the treatment of seed, the application rates of active compound are generally between 0.001 and 50 g per kilogram of seed, preferably between 0.01 and 10 g per kilogram of seed. For treating the soil, the application rates of active compound are generally between 0.1 and 10 000 g/ha, preferably between 1 and 5000 g/ha.

As already mentioned above, all plants and their parts can be treated in accordance with the invention. In a preferred embodiment, plant species and plant varieties which are found in the wild or are obtained by traditional biological breeding methods, such as hybridization or protoplast fusion, and parts of the former are treated. In a further preferred embodiment, transgenic plants and plant varieties which have been obtained by recombinant methods, if appropriate in combination with traditional methods (genetically modified organisms), and their parts are treated. The term “parts” or “parts of plants” or “plant parts” has been illustrated above.

Particularly preferably, plants of the plant cultivars which are in each case commercially available or in use are treated according to the invention. Plant cultivars are understood as meaning plants with new properties (“traits”) which have been obtained by conventional cultivation, by mutagenesis or else by recombinant DNA techniques. These may be cultivars, breeds, biotypes or genotypes.

Depending on the plant species or plant cultivars, their location and growth conditions (soils, climate, vegetation period, nutrition), the treatment according to the invention may also result in superadditive (“synergistic”) effects. Thus, for example, reduced application rates and/or extensions of the activity spectrum and/or an increase in the activity of the substances and compositions that can be used according to the invention, better plant growth, increased tolerance to high or low temperatures, increased tolerance to drought or to water or soil salinity, increased flowering performance, easier harvesting, accelerated maturation, higher harvest yields, better quality and/or a higher nutritional value of the harvested products, better storage stability and/or processability of the harvested products which exceed the effects which were actually to be expected are possible.

The preferred transgenic plants or plant cultivars (i.e. those obtained by genetic engineering) which are to be treated according to the invention include all plants which, as a result of the recombinant modification, received genetic material which imparts particularly advantageous useful properties (“traits”) to these plants. Examples of such properties are better plant growth, increased tolerance to high or low temperatures, increased tolerance to drought or to water or soil salinity, increased flowering performance, easier harvesting, accelerated maturation, higher harvest yields, better quality and/or a higher nutritional value of the harvested products, better storage stability and/or processability of the harvested products. Further and particularly emphasized examples of such properties are a better defence of the plants against animal and microbial pests, such as against insects, mites, phytopathogenic fungi, bacteria and/or viruses, and also increased tolerance of the plants to certain herbicidally active compounds.

### BIOLOGICAL EXAMPLES

### Example 1

### Phakopsora Test (Soybeans)/Protective

Solvent: 28.5 parts by weight of acetone

Emulsifier: 1.5 parts by weight of polyoxyethylene alkyl phenyl ether

To produce a suitable preparation of active compound, 1 part by weight of active compound or active compound combination is mixed with the stated amounts of solvent and emulsifier, and the concentrate is diluted with water to the desired concentration.

To test for protective activity, young plants are sprayed with the preparation of active compound or active compound combination at the stated rate of application. After the spray coating has dried on, the plants are placed in a greenhouse at a temperature of approximately 23° C. and a relative atmospheric humidity of approximately 70%.

1 day after spraying, the plants are inoculated with an aqueous spore suspension of the causal agent of soybean rust (Phakopsora pachyrhizi). The plants are then placed in a greenhouse at approximately 20° C. and a relative atmospheric humidity of approximately 80%.

The test is evaluated 10 days after the inoculation. 0% means an efficacy which corresponds to that of the control, while an efficacy of 100% means that no disease is observed.

The table below clearly shows that the observed activity of the active compound combination according to the invention is greater than the calculated activity, i.e. a synergistic effect is present.

TABLE
Phakopsora test (soybeans)/protective

| | Rate of application | |
|---|---|---|
| Active compound | of active compound | Efficacy |
| Known: | in ppm | in % |
| (I-2) Bixafen | 10 | 50 |
| (III-1) Prothioconazole | 0.5 | 50 |

Inventive Compound combination:

| | | | Rate of | | | |
|---|---|---|---|---|---|---|
| | | | appli- | | | |
| | | | cation | | | Expected |
| | | | of | | | value, |
| | | | active | | | calculated |
| | | Ratio | com- | | | using |
| | | of the | pound | | Actual | Colby's |
| | | mixture | in ppm | | efficacy | formula |
| (I-2) Bixafen | | | 10 | | | |
| + | {close oversize brace} | 20:1 | + | {close oversize brace} | 98 | 75 |
| (III-1) Prothioconazole | | | 0.5 | | | |

1. A method of controlling rust fungi on a plant comprising applying to said plant a composition comprising
(I) at least one carboxamide selected from the group consisting of
(I-1) N-[2-(1,3-dimethylbutyl)phenyl]-5-fluoro-1,3-dimethyl-1H-pyrazole-4-carboxamide;
(I-2) N-(3′,4′-dichloro-5-fluoro-1,1′-biphenyl-2-yl)-3-(difluoromethyl)-1-methyl-1H-pyrazole-4-carboxamide;
(I-3) N-{2-[1,1′-bi(cyclopropyl)-2-yl]phenyl}-1-methyl-3-(difluoromethyl)-1H-pyrazole-4-carboxamide;
(I-4) 3-(difluoromethyl)-1-methyl-N-[9-(propan-2-yl)-1,2,3,4-tetrahydro-1,4-methanonaphthalen-6-yl]-1H-pyrazole-4-carboxamide;
(I-5) N-(3′,4′-dichlorobiphenyl-2-yl)-3-(difluoromethyl)-1-methyl-1H-pyrazole-4-carboxamide;
(I-6) N-(2′,4′-dichlorobiphenyl-2-yl)-3-(difluoromethyl)-1-methyl-1H-pyrazole-4-carboxamide;
(I-7) 3-(difluoromethyl)-N-[2-(1,1,2,3,3,3-hexafluoropropoxy)phenyl]-1-methyl-1H-pyrazole-4-carboxamide;
(I-8) 3-(difluoromethyl)-1-methyl-N-[2-(1,1,2,2-tetrafluoroethoxy)phenyl]-1H-pyrazole-4-carboxamide; and
(I-9) 3-(difluoromethyl)-1-methyl-N-(3′,4′,5′-trifluorobiphenyl-2-yl)-1H-pyrazole-4-carboxamide;
and at least one further compound selected from groups (II) or (III)
(II) strobilurins, selected from the group consisting of
(II-1) fluoxastrobin and
(II-2) trifloxystrobin;
(III) triazoles, selected from the group consisting of
(III-1) prothioconazole
(III-2) tebuconazol; and
(III-3) fluquinconazole

2. The method according to claim 1 wherein the composition comprises at least one carboxamide selected from the group consisting of
(I-1) N-[2-(1,3-dimethylbutyl)phenyl]-5-fluoro-1,3-dimethyl-1H-pyrazole-4-carboxamide;
(I-2) N-(3′,4′-dichloro-5-fluoro-1,1′-biphenyl-2-yl)-3-(difluoromethyl)-1-methyl-1H-pyrazole-4-carboxamide;
(I-3) N-{2-[1,1′-bi(cyclopropyl)-2-yl]phenyl}-1-methyl-3-(difluoromethyl)-1H-pyrazole-4-carboxamide;
(I-4) 3-(difluoromethyl)-1-methyl-N-[9-(propan-2-yl)-1,2,3,4-tetrahydro-1,4-methanonaphthalen-6-yl]-1H-pyrazole-4-carboxamide;
(I-5) N-(3′,4′-dichlorobiphenyl-2-yl)-3-(difluoromethyl)-1-methyl-1H-pyrazole-4-carboxamide;
(I-6) N-(2′,4′-dichlorobiphenyl-2-yl)-3-(difluoromethyl)-1-methyl-1H-pyrazole-4-carboxamide;
(I-7) 3-(difluoromethyl)-N-[2-(1,1,2,3,3,3-hexafluoropropoxy)phenyl]-1-methyl-1H-pyrazole-4-carboxamide;
(I-8) 3-(difluoromethyl)-1-methyl-N-[2-(1,1,2,2-tetrafluoroethoxy)phenyl]-1H-pyrazole-4-carboxamide;
(I-9) 3-(difluoromethyl)-1-methyl-N-(3′,4′,5′-trifluorobiphenyl-2-yl)-1H-pyrazole-4-carboxamide;
in combination with fluoxastrobin.

3. The method according to claim 1 wherein the composition comprises at least one carboxamide selected from the group consisting of
(I-1) N-[2-(1,3-dimethylbutyl)phenyl]-5-fluoro-1,3-dimethyl-1H-pyrazole-4-carboxamide;
(I-2) N-(3′,4′-dichloro-5-fluoro-1,1′-biphenyl-2-yl)-3-(difluoromethyl)-1-methyl-1H-pyrazole-4-carboxamide;
(I-3) N-{2-[1,1′-bi(cyclopropyl)-2-yl]phenyl}-1-methyl-3-(difluoromethyl)-1H-pyrazole-4-carboxamide;
(I-4) 3-(difluoromethyl)-1-methyl-N-[9-(propan-2-yl)-1,2,3,4-tetrahydro-1,4-methanonaphthalen-6-yl]-1H-pyrazole-4-carboxamide;
(I-5) N-(3′,4′-dichlorobiphenyl-2-yl)-3-(difluoromethyl)-1-methyl-1H-pyrazole-4-carboxamide;
(I-6) N-(2′,4′-dichlorobiphenyl-2-yl)-3-(difluoromethyl)-1-methyl-1H-pyrazole-4-carboxamide;
(I-7) 3-(difluoromethyl)-N-[2-(1,1,2,3,3,3-hexafluoropropoxy)phenyl]-1-methyl-1H-pyrazole-4-carboxamide;
(I-8) 3-(difluoromethyl)-1-methyl-N-[2-(1,1,2,2-tetrafluoroethoxy)phenyl]-1H-pyrazole-4-carboxamide; and
(I-9) 3-(difluoromethyl)-1-methyl-N-(3′,4′,5′-trifluorobiphenyl-2-yl)-1H-pyrazole-4-carboxamide;
in combination with trifloxystrobin.

4. The method according to claim 1 wherein the composition comprises at least one carboxamide selected from the group consisting of
(I-1) N-[2-(1,3-dimethylbutyl)phenyl]-5-fluoro-1,3-dimethyl-1H-pyrazole-4-carboxamide;
(I-2) N-(3′,4′-dichloro-5-fluoro-1,1′-biphenyl-2-yl)-3-(difluoromethyl)-1-methyl-1H-pyrazole-4-carboxamide;
(I-3) N-{2-[1,1′-bi(cyclopropyl)-2-yl]phenyl}-1-methyl-3-(difluoromethyl)-1H-pyrazole-4-carboxamide;
(I-4) 3-(difluoromethyl)-1-methyl-N-[9-(propan-2-yl)-1,2,3,4-tetrahydro-1,4-methanonaphthalen-6-yl]-1H-pyrazole-4-carboxamide;
(I-5) N-(3′,4′-dichlorobiphenyl-2-yl)-3-(difluoromethyl)-1-methyl-1H-pyrazole-4-carboxamide;
(I-6) N-(2′,4′-dichlorobiphenyl-2-yl)-3-(difluoromethyl)-1-methyl-1H-pyrazole-4-carboxamide;
(I-7) 3-(difluoromethyl)-N-[2-(1,1,2,3,3,3-hexafluoropropoxy)phenyl]-1-methyl-1H-pyrazole-4-carboxamide;
(I-8) 3-(difluoromethyl)-1-methyl-N-[2-(1,1,2,2-tetrafluoroethoxy)phenyl]-1H-pyrazole-4-carboxamide; and
(I-9) 3-(difluoromethyl)-1-methyl-N-(3′,4′,5′-trifluorobiphenyl-2-yl)-1H-pyrazole-4-carboxamide;
in combination with prothioconazole.

5. The method according to claim 1 wherein the composition comprises at least one carboxamide selected from the group consisting of
(I-1) N-[2-(1,3-dimethylbutyl)phenyl]-5-fluoro-1,3-dimethyl-1H-pyrazole-4-carboxamide;
(I-2) N-(3′,4′-dichloro-5-fluoro-1,1′-biphenyl-2-yl)-3-(difluoromethyl)-1-methyl-1H-pyrazole-4-carboxamide;
(I-3) N-{2-[1,1′-bi(cyclopropyl)-2-yl]phenyl}-1-methyl-3-(difluoromethyl)-1H-pyrazole-4-carboxamide;
(I-4) 3-(difluoromethyl)-1-methyl-N-[9-(propan-2-yl)-1,2,3,4-tetrahydro-1,4-methanonaphthalen-6-yl]-1H-pyrazole-4-carboxamide;
(I-5) N-(3′,4′-dichlorobiphenyl-2-yl)-3-(difluoromethyl)-1-methyl-1H-pyrazole-4-carboxamide;
(I-6) N-(2′,4′-dichlorobiphenyl-2-yl)-3-(difluoromethyl)-1-methyl-1H-pyrazole-4-carboxamide;
(I-7) 3-(difluoromethyl)-N-[2-(1,1,2,3,3,3-hexafluoropropoxy)phenyl]-1-methyl-1H-pyrazole-4-carboxamide;
(I-8) 3-(difluoromethyl)-1-methyl-N-[2-(1,1,2,2-tetrafluoroethoxy)phenyl]-1H-pyrazole-4-carboxamide; and
(I-9) 3-(difluoromethyl)-1-methyl-N-(3′,4′,5′-trifluorobiphenyl-2-yl)-1H-pyrazole-4-carboxamide;
in combination with tebuconazole.

6. The method according to claim 1 wherein the composition comprises at least one carboxamide selected from the group consisting of
(I-1) N-[2-(1,3-dimethylbutyl)phenyl]-5-fluoro-1,3-dimethyl-1H-pyrazole-4-carboxamide;
(I-2) N-(3′,4′-dichloro-5-fluoro-1,1′-biphenyl-2-yl)-3-(difluoromethyl)-1-methyl-1H-pyrazole-4-carboxamide;
(I-3) N-{2-[1,1′-bi(cyclopropyl)-2-yl]phenyl}-1-methyl-3-(difluoromethyl)-1H-pyrazole-4-carboxamide;
(I-4) 3-(difluoromethyl)-1-methyl-N-[9-(propan-2-yl)-1,2,3,4-tetrahydro-1,4-methanonaphthalen-6-yl]-1H-pyrazole-4-carboxamide;
(I-5) N-(3′,4′-dichlorobiphenyl-2-yl)-3-(difluoromethyl)-1-methyl-1H-pyrazole-4-carboxamide;
(I-6) N-(2′,4′-dichlorobiphenyl-2-yl)-3-(difluoromethyl)-1-methyl-1H-pyrazole-4-carboxamide;
(I-7) 3-(difluoromethyl)-N-[2-(1,1,2,3,3,3-hexafluoropropoxy)phenyl]-1-methyl-1H-pyrazole-4-carboxamide;
(I-8) 3-(difluoromethyl)-1-methyl-N-[2-(1,1,2,2-tetrafluoroethoxy)phenyl]-1H-pyrazole-4-carboxamide; and
(I-9) 3-(difluoromethyl)-1-methyl-N-(3′,4′,5′-trifluorobiphenyl-2-yl)-1H-pyrazole-4-carboxamide;
in combination with fluquinconazole.

7. (canceled)

8. The method according to claim 1 wherein said rust is selected from the group consisting of soy bean rust and coffee rust.

9. Process for controlling a disease of soy bean plants, characterized in that the soy bean plants are treated with a fungicidal composition comprising
(I) at least one carboxamide selected from the group consisting of
(I-1) N-[2-(1,3-dimethylbutyl)phenyl]-5-fluoro-1,3-dimethyl-1H-pyrazole-4-carboxamide;
(I-2) N-(3′,4′-dichloro-5-fluoro-1,1′-biphenyl-2-yl)-3-(difluoromethyl)-1-methyl-1H-pyrazole-4-carboxamide;
(I-3) N-{2-[1,1′-bi(cyclopropyl)-2-yl]phenyl}-1-methyl-3-(difluoromethyl)-1H-pyrazole-4-carboxamide;
(I-4) 3-(difluoromethyl)-1-methyl-N-[9-(propan-2-yl)-1,2,3,4-tetrahydro-1,4-methanonaphthalen-6-yl]-1H-pyrazole-4-carboxamide;
(I-5) N-(3′,4′-dichlorobiphenyl-2-yl)-3-(difluoromethyl)-1-methyl-1H-pyrazole-4-carboxamide;
(I-6) N-(2′,4′-dichlorobiphenyl-2-yl)-3-(difluoromethyl)-1-methyl-1H-pyrazole-4-carboxamide;
(I-7) 3-(difluoromethyl)-N-[2-(1,1,2,3,3,3-hexafluoropropoxy)phenyl]-1-methyl-1H-pyrazole-4-carboxamide;
(I-8) 3-(difluoromethyl)-1-methyl-N-[2-(1,1,2,2-tetrafluoroethoxy)phenyl]-1H-pyrazole-4-carboxamide; and
(I-9) 3-(difluoromethyl)-1-methyl-N-(3′,4′,5′-trifluorobiphenyl-2-yl)-1H-pyrazole-4-carboxamide;
and at least one further compound selected from the group consisting of
(II) strobilurins, which are selected from the group consisting of
(II-1) fluoxastrobin and
(II-2) trifloxystrobin;
or from
(III) triazoles, which are selected from the group consisting of
(III-1) prothioconazole;
(III-2) tebuconazole; and
(III-3) fluquinconazole.

10. Process according to claim 9 wherein the soy bean plants are transgenic soy bean plants.

11. (canceled)

12. Process according to claim 9 wherein said disease is caused by Alternaria spec. atrans tenuissima, Colletotrichum gloeosporoides dematium var. truncatum, Septoria glycines, Cercospora kikuchii, Choanephora infundibulifera trispora (syn.), Dactuliophora glycines, Peronospora manshurica, Drechslera glycini, Cercospora sojina, Leptosphaerulina trifolii, Phyllosticta sojaecola, Microsphaera diffusa, Pyrenochaeta glycines, Rhizoctonia solani, Phakopsora pachyrhizi, Sphaceloma glycines, Stemphylium botryosum, Corynespora cassiicola, Calonectria crotalariae, Macrophomina phaseolina, Fusarium oxysporum, Fusarium orthoceras, Fusarium semitectum, Fusarium equiseti, Mycoleptodiscus terrestris, Neocosmopspora vasinfecta, Diaporthe phaseolorum, Diaporthe phaseolorum var. caulivora, Phytophthora megasperma, Phialophora gregata, Pythium aphanidermatum, Pythium irregulare, Pythium debaryanum, Pythium myriotylum, Pythium ultimum, Rhizoctonia solani, Sclerotinia sclerotiorum, Sclerotinia rolfsii or Thielaviopsis basicola.

13. Process according to claim 9 wherein said disease is alternaria leaf spot, anthracnose, brown spot, cercospora leaf spot and blight, choanephora leaf blight, dactuliophora leaf spot, downy mildew, drechslera blight, frogeye leaf spot, leptosphaerulina leaf spot, phyllostica leaf spot, powdery mildew, pyrenochaeta leaf spot, rhizoctonia aerial, foliage, and web blight, rust, scab, stemphylium leaf blight, target spot, black root rot, charcoal rot, fusarium blight or wilt, root rot, and pod and collar rot, mycoleptodiscus root rot, neocosmospora, pod and stem blight, stem canker, phytophthora rot, brown stem rot, pythium rot, rhizoctonia root rot, stem decay, and damping-off, sclerotinia stem decay, sclerotinia southern blight or thielaviopsis root rot.

14. The method according to claim 1 wherein the composition comprises at least one (I) carboxamide and a (II) strobilurin.

15. The method according to claim 14 wherein the ratio of the at least one (I) carboxamide to the (II) strobilurin is from 50:1 to 1:50.

16. The method according to claim 1 wherein the composition comprises the at least one (I) carboxamide and a (III) triazole.

17. The method according to claim 16 wherein the ratio of the at least one (I) carboxamide to the (III) triazole is from 50:1 to 1:50.
